(19) United States
(12) Patent Application Publication
(10) Pub. No.: US 2002/0164971 A1
(43) Pub. Date: Nov. 7, 2002

(54) Method and apparatus in a microwave system

(76) Inventors: Dan Weinholt, Vastra Frolunda (SE); Gunnar Skatt, Molndal (SE)

Correspondence Address: Brian D. Walker, Esq., Jenkens and Gilchrist, P.C., 3200 Fountain Place, 1445 Ross Ave., Dallas, TX, 75202, US

(21) Appl. No.: 10/098,010

(22) Filed: Mar. 14, 2002

(30) Foreign Application Priority Data
Mar. 30, 2001 (SE) 0101158-4

(51) Int. Cl. H04B 1/26

(52) U.S. Cl. 455/323; 455/313; 455/318

(57) ABSTRACT

The present invention use the properties of a TDD-transmission on a general mixer in such a manner that in the transmit mode a first RF signal is amplified in the mixer with an amplification factor greater than, or equal to, or less than one, and in the receive mode the received RF signal is mixed with a second RF signal.

### TECHNICAL FIELD OF THE INVENTION

The present invention generally concerns methods relating to a microwave system. Specifically, the present invention relates to mixing methods operating during a transmit and receive mode and mixers operating in a transmit and receive mode in a TDD (Time Division Duplex) system.

### DESCRIPTION OF RELATED ART

One way of reducing the hardware cost of a transmission network is to use Time Division Duplex (TDD), which means that the communication between two points use the same frequency slot in both directions but are separated in time instead of frequency. Usually transmission is performed in one frame slot while receiving is done in a time slot of a subsequent frame.

In the transmission network of the TDD system, one of the most technology-intensive portions is the transmitter-receivers. Various circuit functions must be implemented in the transmitter-receivers including oscillators, low-noise amplifiers, mixers, power amplifiers, frequency multipliers, frequency dividers, and power detectors.

In a TDD system, transmit and receive circuitry within the transmission network can share hardware. An example of such hardware is the front-end filters, which filter the same frequency in the receive or transmit mode. In addition, less internal isolation is required between transmit and receive circuitry. For these reasons, e.g. transmit and receive circuitry which operates using TDD can be cheaper.

An example of an element in a transmit and receive circuitry is the mixer, which is a device with a basic function of performing a frequency transposition of the incoming signal.

In the front-end of a receiver containing a mixer, an incoming signal (of varying frequency) is mixed with a local oscillator (LO) or frequency synthesizer signal, to yield a fixed Intermediate Frequency (IF). In a transmitter, the incoming modulated signal is mixed with a carrier to give an output radio frequency signal after filtering (transmission IF).

Mixers have many functions, sometimes going by another name. In an exemplary mixer with two inputs, one with frequency fs, contains the information signal, the second, fo, is specifically generated to shift that information signal to any positive value of ±fo±fs, of which only one is the desired output. In addition, the mixer output contains input frequencies, their harmonics, and the sum and difference frequencies of any two of all those.

The most important characteristics of a mixer is the conversion gain or conversion loss. It is expressed, in decibels, as the output level over the signal input level (i.e. the ratio of the level of the wanted output signal to that of the input signal). Positive decibel figures mean gain, negative mean attenuation. Noise is generated in all mixers. It is quantified as a noise figure, expressed in decibels over the noise generated by a resistor of the same value as the impedance of the mixer port at the prevailing temperature, e.g. 50Ω at 17° C. The mixer spurious attenuation is the attenuation of unwanted mixing products in the output relative to the wanted signal. Isolation between the input ports of a mixer refers to the input applied to one port affecting whatever is connected to the other input port. Further, overload, compression and intermodulation products cause problems for the mixer performance.

Any device with a non-linear voltage/current characteristic can serve as a mixer. However, the output amplitude of an ideal mixer shows a linear (proportional) relationship to the amplitude of one input, the signal, if the amplitude on the other input, e.g. from the Local Oscillator (LO), is kept constant. Diodes, bipolar transistors, junction FETs, single and dual-gate MOSFETs, as well as their valve equivalents are used as mixers.

### SUMMARY OF THE INVENTION

The problem dealt with by the present invention is the restrained performance of a mixer in a transmission network, a reduced power output being the result due to conversion loss in the mixer. Further problems are increasing production costs and the demand for reduced physical size of the equipment in the transmission network.

Briefly the present invention solves said problem by using the properties of the TDD-transmission on a general RF mixer in such a manner that in the transmit mode a first RF signal is amplified in the mixer with an amplification factor greater than, or equal to, or less than one, and in the receive mode the received RF signal is mixed with a second RF signal.

Specifically, the problem is solved by the method according to claim 1 and the apparatus according to claim 13.

An object of the invention is to provide a method for using the mixing characteristics of a known mixer in the transmit and the receive mode resulting in a mixer which works with less conversion loss and a mixer which reduces the cost for the production of the transceiver in a transmission network.

Another object of the invention is to provide a general mixer circuit with three ports using the properties of a TDD-signal.

Yet another object of the invention is to avoid the need of using a switch.

Yet further another object of the invention is reducing the physical size of the transceiver in the transmission network.

An advantage of the present invention is increased linearity in the whole transmission network and during transmit mode reduced conversion losses in the mixer.

Yet another advantage of the invention is to avoid the need of using a switch and in transmit mode an amplifier.

Yet still further another advantage is reducing the cost for the production of the transceiver in a transmission network.

Still another advantage of the present invention is a decreased physical size of the transceiver for a transmission network.

Other objects, advantages and novel features of the invention will become apparent from the following detailed description of the invention when considered in conjunction with the accompanying drawings and claims.

### DESCRIPTION OF THE DRAWINGS

FIG. 1 is a block diagram in a TDD system illustrating a function of a transceiver according to prior art.

FIG. 2 is a block diagram in a TDD system illustrating a function of a similar transceiver as in FIG. 2 according to prior art.

FIG. 3 is a block diagram illustrating a mixer with its ports.

FIG. 4 is a block diagram in a TDD system illustrating a general overview of a function of a transceiver according to the invention.

FIG. 5 is a block diagram illustrating the function of the transceiver in FIG. 4 in the transmit mode according to the invention.

FIG. 6 is a block diagram illustrating the function of the transceiver in FIG. 4 in the receive mode according to the invention.

FIG. 7 is a circuit diagram illustrating one example of a mixer according to the invention.

### DESCRIPTION OF PREFERRED EMBODIMENTS

FIG. 1 illustrates a part of an exemplary transceiver 100 in a Time Division Duplex (TDD) system. Normally, in such a TDD system the transceiver comprises a complete receiver and transmitter with a switch, controlled by a TDD Control signal S100, to change between receive and transmit mode. In the exemplary transceiver 100 in FIG. 1 with a switch 160 in transmit mode, the information carrying baseband signal S180 with an application specific information bandwidth is modulated by the modulator (MOD) 180 into another signal S170 with another application specific modulated bandwidth and center frequency fl70 defined by the carrier frequency. The modulated signal S170 is connected to an amplifier 170, which amplifies the signal S140 before it is filtered in the front-end filter 140. The antenna (ANT) 150 then transmits the modulated and filtered signal S160.

In the front-end filter 140, all other components are suppressed as e.g. harmonics, spurious signals and intermodulation products, beside the RF signal S160 which is to be transmitted by the antenna (ANT) 150 into the air.

With the switch 160 in the receive mode, the received RF signal S150, from the antenna 150, is first filtered by the front-end filter 140 resulting in a filtered received RF signal S130. Which is then e.g. mixed down in the mixer 130 with a RF signal S110 produced by a Local Oscillator (LO) 110. The product from the mixer is the Intermediate Frequency (IF) signal S120. The IF signal S120 is then demodulated by the demodulator (DEM) 120 to extract the baseband signal S190. For an ideal transmission system arrangement (i.e. information signal S180 transmitted from one terminal to a receiving terminal) without distortion the extracted baseband signal S190 is identical with the information carrying baseband signal S180 into the modulator (MOD) 180. Further in FIG. 1 a TDD Control signal S100 is shown connected to the demodulator (DEM) 120 and modulator (MOD) 180 of the baseband signal S190 and information carrying signal S180, respectively. TDD Control signal S100 is also connected to the switch 160, which controls the switch 160 to switch between the receive and transmit mode in correspondence to the rate of the TDD frame. The TDD Control signal S100 here, symbolizes the synchronization between receive mode and the demodulator (DEM) 120 working and synchronization between transmit mode and modulator (MOD) 180 working.

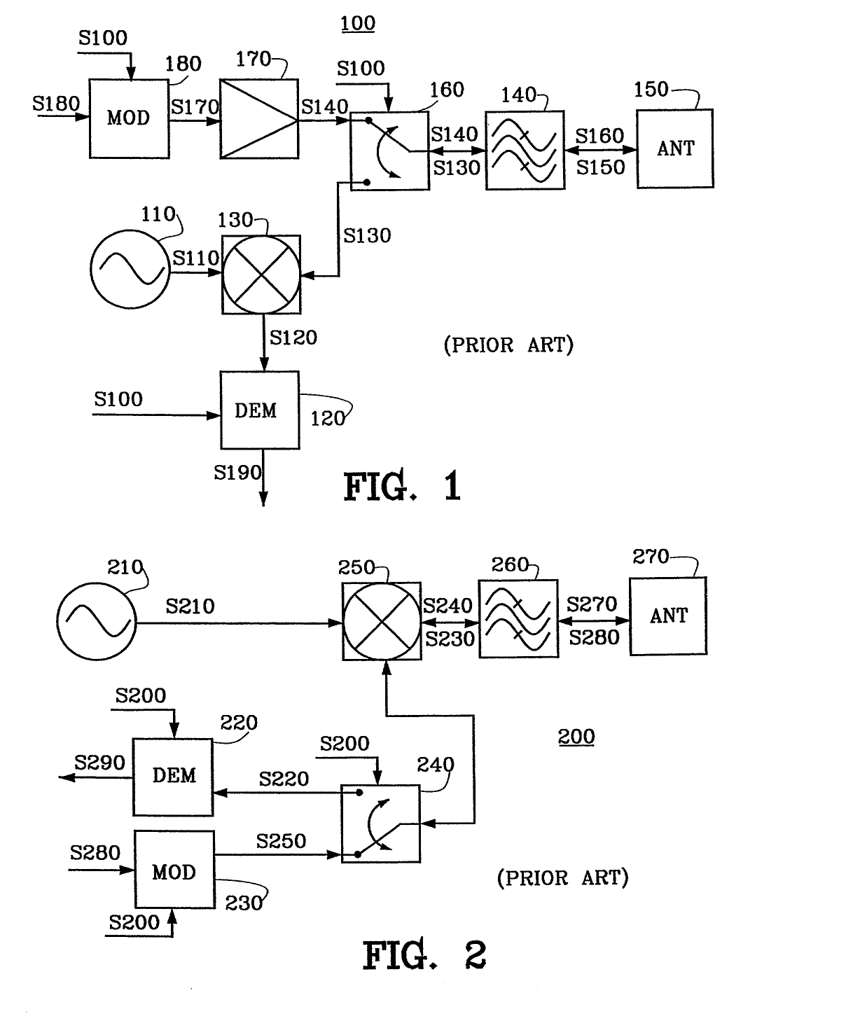

FIG. 2 illustrates a part of an exemplary transceiver 200 in a Time Division Duplex (TDD) system similar to the transceiver in FIG. 1. The main difference is how the mixer 250 is placed in the transceiver; directly next to the front end filter 260, corresponding to the front-end filter 140 in FIG. 1. The result of placing the mixer 250 there next to the front-end filter and after the modulator (MOD) 230 is that the information carrying baseband signal S280, modulated by the modulator (MOD) 230 into another signal S250 with another application specific modulated bandwidth and center frequency f250, e.g. preferably can be up-converted by the mixer 250, which is not the case for the modulated signal S170 in FIG. 1. Another difference of FIG. 2 is the placement of the switch 240, here in FIG. 2 the switch in transmit mode receive the modulated signal S250 into the mixer 250 and in receive mode the received IF signal S220 from the mixer 250 is passed through the switch 240 and further inputted into the demodulator (DEM) 220. The demodulated signal S290 in FIG. 2 is corresponding to the demodulated signal S190 in FIG. 1. By this arrangement switches in the RF-frequency path is avoided. As further signals and components in FIG. 1 correspond to: S100⇄S200, 110⇄210, 180⇄230, 120⇄220, 140⇄260, 150⇄270, S180⇄S280, S170⇄S250, S160⇄S270, S150⇄S280, S130⇄S230, S120⇄S220, in FIG. 2.

In FIG. 3 a block diagram 300 is shown of a mixer 330 with its first S300, second S310, and third S320 input signals and its output signal S330. In a general mixer 330, the second S310 and third S320 input signals are multiplied,

S330=S310·S320

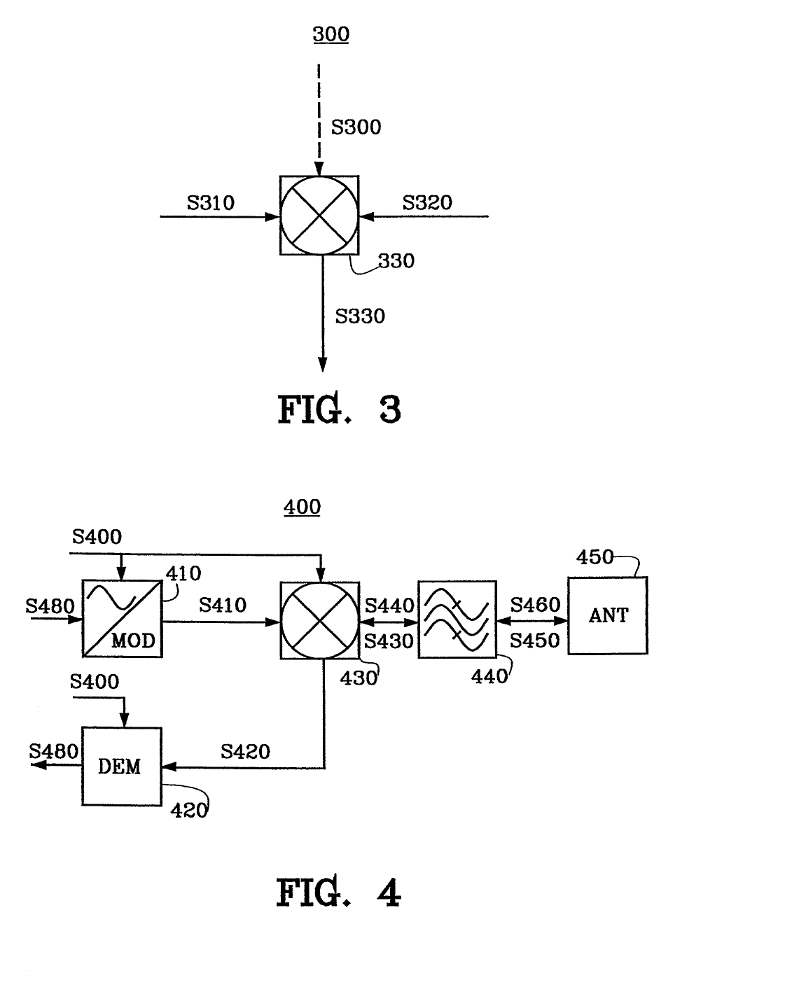

resulting in the product output signal S330. If the mixer 330 is ideal no spurious signals is produced by the mixer 330 and no intermodulation products will be found in the output signal S330. The first input signal S300 symbolizes the TDD Control signal S400, S500, S600 in FIG. 4-6 that is further explained below where for example the mode of the mixer can be changed according to the invention. It should be noted that the realization of the TDD Control signal S300 need not be by a separate input signal of the mixer 330, e.g. it may be connected to any of the other two input signals S310 or S320, or the TDD Control signal S300 may just change the use of an input port to an output port.

When the second S310 and third S320 input signals are two sinusoidal signals described as,

S310=Ŝ₃₁₀·sin(w₃₁₀t)

and

S320=Ŝ₃₂₀·sin(w₃₂₀t),

as the corresponding frequencies for the second signal S310 is f310 and third signal S320 is f320 (w₃₁₀=2πf₃₁₀, w₃₂₀ =2πf₃₂₀), the signal product S330 is mathematically described as,

$$S330 = \frac{1}{2} {\sum }_{m , n} {\hat{S}}_{310 m , n} \cdot {\hat{S}}_{320 m , n} ( \begin{matrix}cos ( {mw}_{310} - {nw}_{320} ) - \\ cos ( {mw}_{310} + {nw}_{320} )\end{matrix} ) ,$$

where Ŝ₃₁₀ and Ŝ₃₂₀ are top amplitude of the input signals, and m and n is the order of the harmonics.

In FIG. 1 and FIG. 2 the TDD Control signal S100 and S200 control a switch, which is switching between transmit and receive mode. At high RF frequencies a switch with high performance and with low disturbance properties is expensive. In FIG. 1, with a switch so close to the antenna, affect the linearity of the transceiver. For both the prior art transceivers in FIG. 1 and FIG. 2 the conversion losses for the mixers 130 and 250 are high. Normally, in the prior art both the transmitted and received signal need to be amplified. In FIG. 1 it is illustrated by the amplifier 170 next to the modulator (MOD) 180. In receive mode an amplifier placed in FIG. 1 after the switch 160 (in between the switch 160 and mixer 130) could help to amplify an often weak received RF signal S150. An amplifier and a switch increase the size of the transceiver, affect the linearity and are a costly pieces of a radio equipment at high frequencies.

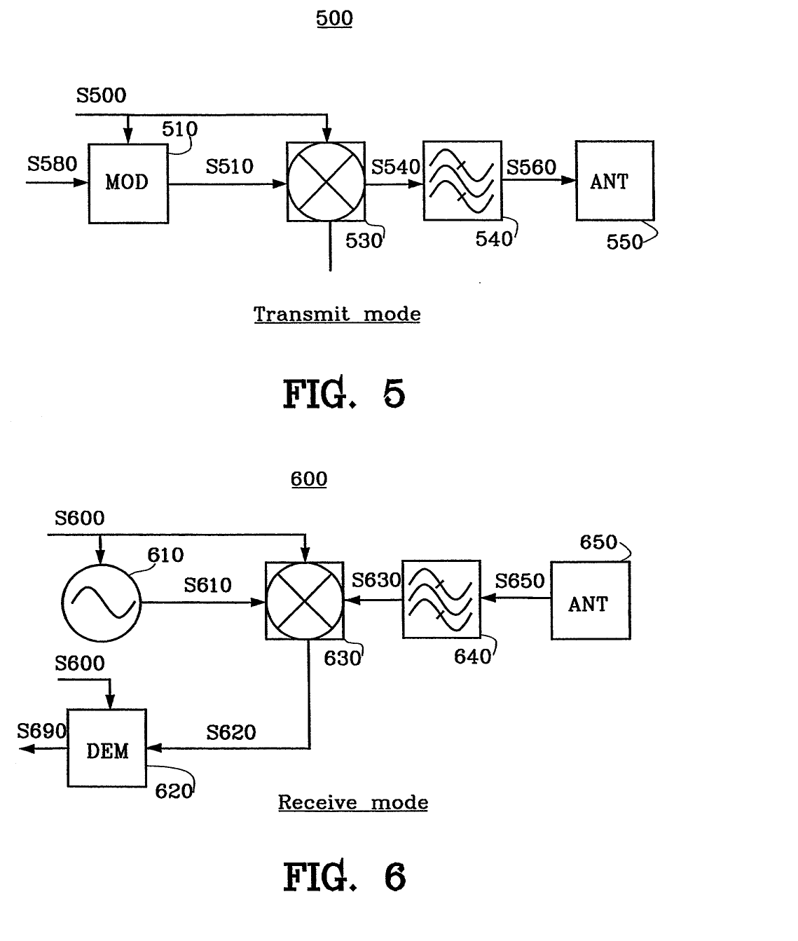

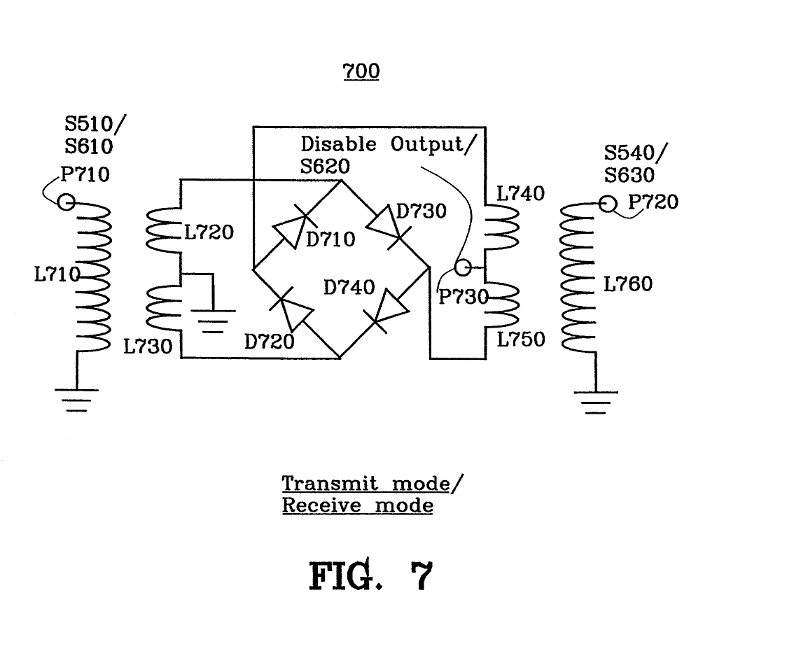

A general overview of one exemplary transceiver 400 according to the invention is illustrated in FIG. 4. In FIG. 5 and 6 is this general overview divided up into two parts 500, 600 to separately illustrate when the transceiver 400 in FIG. 4 is in its transmit (FIG. 5) and receive (FIG. 6) mode. The block diagrams of the exemplary embodiment in FIG. 4-6 is a part of a transceiver 400, 500, 600 used in a TDD system. The block diagram in FIG. 4 show an oscillating means block 410, a mixer 430, a front-end filter 440, antenna 450 and demodulator 420. The oscillating means block 410 and mixer 430 and demodulator (DEM) 420 are all controlled by the TDD Control signal S400. It has a rate of a TDD frame, thus in the exemplary transceiver 400 according to the invention, the TDD Control signal S400 switches mode (functionality) of the mixer 430 and the oscillating means block 410. As described above the TDD Control signal S400 connected to the demodulator (DEM) 420 is just symbolizing the synchronization between the receive mode and demodulator (DEM) 420 working. The change of mode (functionality change) is coordinated with receive and transmit mode. With the TDD Control signal S400 connected to the mixer 430 in FIG. 4 the TDD Control signal S400 may interfere with the other incoming signals to the mixer, but as the TDD Control signal S400 consists of a direct current (DC) signal, its value does not affect the mixer product output S420. However, one skilled in the art will recognize that another solution is not to give the TDD Control signal S400 a value that is mixed with the other incoming signals to the mixer. Instead, a value is given that only implies controlling the functionality of the mixer, i.e. shifting the mixer function between amplifier (attenuator mode depending on the implementation) and mixer mode. Another solution is to switch direction of at least one signal into the ports of the mixer, e.g. change direction of a signal such as an input port in transmit mode change into an output port in receive mode.

The oscillating means block 410 in FIG. 4, is symbolizing the modulator (MOD) 510 in FIG. 5 in transmit mode, and the local oscillator (LO) 610 in FIG. 6 in receive mode. In transmit mode, illustrated in more detail in FIG. 5, the same oscillating means block 410 and information carrying baseband signal S480 into the oscillating means block 410 in FIG. 4, is illustrated in FIG. 5 as an information carrying baseband signal S580. The modulator 510 in FIG. 5, modulates the incomming information carrying baseband signal S580 into a first RF signal S510 (in transmit mode, corresponding to first RF signal S410 in FIG. 4) with another application specific modulated bandwidth and center frequency f510 defined by the carrier frequency.

In transmit mode the mixer 530 transfers the first RF signal S510 with or without amplification (amplify the first RF signal S510 with an amplification factor greater, or equal, or less than one) resulting in the transmitted RF signal S540 (S540=K·S510 when −∞≦K≦∞). If first RF signal S510 is a sinusoidal signal,

S510=Ŝ₅₁₀ ·sin(w₅₁₀t)

when w₅₁₀ =2πf₅₁₀ and m is the order of an harmonic and Kₘ (−∞≦Kₘ≦∞) symbolizes an amplification or attenuating factor connected to each harmonics m, the output signal of the mixer will be,

S540=Kₘ ·Ŝ₅₁₀·sin(mw₅₁₀t).

By transferring the first RF signal S510 with or without amplification through the mixer 530, the mixer 530 will not cause any conversion losses. Dependant on how the filter bandwidth is set the signal after the filter 540 can be changed, thus here, the signal input to the filter S540 equals the signal after the filter S560 (S540=S560). The amplification factor (−∞≦Kₘ ≦∞) is dependent on how well the mixer is performing as an amplifier. In a mixer with passive components there will be an attenuation for the first RF signal SS10, while in a mixer with active components, an amplification factor greater than one can be expected.

In receive mode, illustrated in more detail in FIG. 6, the oscillating means 610, a Local Oscillator (LO) 610, produces a second RF signal S610 so the received RF signal S650 (in air from the antenna 650), after being filtered S630, is e.g. down-converted by the mixer 630. The change of frequency (i.e. the frequency change of the signal between first RF signal f510 and second RF signal f610) for the signal produced by the oscillating means 610 is controlled as said above by the TDD Control signal S600. In FIG. 6, also the Local Oscillator (LO) 610 can be symbolized with the same modulator block (MOD) 510 as in FIG. 5, with the information baseband carrying signal S580 equal to zero. The modulator would then produce a local oscillating (LO) signal, a second RF signal S610. However, one skilled in the art will recognize that the second RF signal S610 described above to be a local ocillating (LO) signal, may also be a modulated information signal with a modulated bandwith. The result after mixing the second RF signal when the second RF signal S610 has a modulated bandwith with a certain center frequency f610, with the receiving RF signal S630 (which has another modulated bandwith and center frequency) will be a signal with two modulated information signals. In a further step the information signal comming from the oscillating means 610 can be removed since it is a known signal and the information signal from the receiving RF signal S630 can be obtained. One skilled in the art will recognize further that a filter may be placed before the demodulator (DEM) 620 or/and after the oscillating means 510, 610 to filter out frequencies of interest.

Further in the receive mode, a direct demodulating mode can be implemented, in which the second RF signal S610 from the oscillating means 610 is mixed in the mixer 630 with the received RF signal S650 (in air from the antenna 650) in such a way so the resulting signal S620 out of the mixer 630 is equal to the demodulated signal S690 out of the demodulator (DEM) 620, which is the same function as if the demodulator (DEM) 620 is included in the mixer 630.

In receive mode, illustrated in FIG. 6, the mixer 630 is mixing the second RF signal S610 from the oscillating means 610 with the filtered received RF signal S630 i.e.,

S620=S610·S630

resulting in the frequency product,

f620=|±f610∓f630|

|f610+f630|, |f610−f630|, |−f610−f630|, |−f610+f630|)

if the corresponding frequency for each signal is,

S620⇄f620, S610⇄f610, S630⇄f630.

The frequency of the RF signal S560 to be transmitted (after it has first been modulated, then amplified with an amplification factor greater or less than one, and lastly filtered) and the receiving RF signal S650 from air is normally the same (f560=f650, if the corresponding frequency for each signal is S560⇄f560 and S650⇄f650), but different frequencies (f560≠f650) can also be used.

The function of the filter 440, 540, 640 in general for the receive and transmit mode is to select the frequency band in use. In receive mode, according to FIG. 6 the frequency f610 of the second RF signal S610 is selected so that together with the filter 640 the resulting IF signal S620 out of the mixer 630 into the demodulator (DEM) 620 is chosen so that when f610≦f650 only the frequency of the second RF signal f610 minus the frequency f650 of receiving RF signal S650 from air (f610−f650), or when f610≦f650 the frequency f650 of receiving RF signal S650 from air minus the frequency f610 of second RF signal S610 (f650−f610) is the used product of the mixer 630. But this all depends on which IF signal S620 is of interest in the application.

In FIG. 7 is illustrated a circuit diagram 700 of an exemplary practical realization of the mixer 430, 530, 630 in FIG. 4-6 according to the invention. The circuit diagram in FIG. 7 shows an exemplary double balanced mixer 700 including: three ports S510/S610 port P710, S540/S630 port P720, and Disable Output/S620 port P730, a diode bridge D710, D720, D730 and D740, and a first primary winding L710, a second primary winding L760 and a first secondary winding L720+L730, and second secondary winding L740+L750. The double balanced mixer 700 can e.g. be studied by the data sheet of Blue Cell Technology with model product number starting with MBA (see the design engineers search engine http://www.minicircuits.com) . In general such double balanced mixer 700 when a square wave local oscillator (LO) signal is applied to S510/S610 port P710 (at first primary winding L710) the diodes D710, D720, D730, D740 of the diode bridge (between first secondary winding L720+L730 and second secondary winding L740+L750) is switching between forward and reverse bias, and the diode bridge functions as a polarity changer, with switching occuring at every half-cycle of the square wave local oscillator (LO) signal. How the double balanced mixer work in general can further be studied in Straw R. D. (2000) The ARRL Handbook For Radio Amateurs, (75 Edition) Newington, Conn. 06111 USA: ARRL-the national association for Amateur Radio. In a perfectly balanced arrangement as could be for the mixer in FIG. 7, the input frequency/frequencies is/are supressed at the output ports. Realizing the mixer 430, 530, 630 in FIG. 4-6, when the mixer 430, 530, 630 is in transmit or receive mode, the output from the oscillating means 410, 510, 610 is connected to the S510/S610 port P710 at the first primary winding L710. The TDD Control signal S400, S500, S600 is here connected to the double balanced mixer 700 as illustrated for the mixer 430, 530, 630 in FIG. 4-6. The TDD Control signal S400, S500, S600 is a square wave of a frequency of a TDD frame and a voltage of approximately +3 VDC during transmit mode and approximately 0 VDC during receive mode. Actually the TDD Control signal S400, S500, S600 is connected to the Disable Output/S620 port P730, resulting in a positive voltage supply added to the diode bridge D710, D720, D730, D740 during transmit mode, forward biasing the diodes D710 (between upper first secondary winding L720 and upper second secondary winding L740), and D740 (between lower first secondary winding L730 and lower second secondary winding L750) in the diode bridge. The TDD Control signal S400, S500, S600, in this one exemplary mixer 700, is also controlling the S540/S630 port P720 at the second primary winding L760. So when in transmit mode the first RF signal S540 in FIG. 5 is outputted from S540/S630 port P720 after the signal has been amplified with an amplification factor greater than, or equal to, or less than one and when in receive mode the received RF signal S630 in FIG. 6 is inputted into S540/S630 port P720. As described in section where FIG. 4 is described, the direction of the signal is actually changed. Accordingly in transmit mode is the Disable Output/S620 port P730 between the windings of the second secondary winding L740+L750 disabled and in receive mode the IF signal S620 is outputted (generated from incomming second RF signal S610 being mixed with filtered received RF signal S630). The Disable Output/S620 port P730 is further connected to the demodulator (DEM) 620. However, one skilled in the art will recognize that another solution for the TDD Control signal is applicable (see section where the TDD Control signal for FIG. 3 and FIG. 4 is described), it is all depending on which mixer circuit is choosen.

As a person skilled in the art appreciates, application of the invention is in no way limited to only TDD system networks.

As will be recognized by those skilled in the art, the innovative concepts described in the present application can be modified and varied over a wide range of applications. Accordingly, the scope of patented subject matter should not be limited to any of the specific exemplary teachings discussed.

1. A method of operating a mixer in a transmit and a receive mode, comprising the steps of:
in said transmit mode, providing a first RF signal to said mixer, amplifying said first RF signal, with an amplification factor greater than, or equal to, or less than one in said mixer; and
in said receive mode, providing a second RF signal to said mixer, generating a received IF signal by mixing a received RF signal with said second RF signal in said mixer.

2. A method according to claim 1, further comprising the step of operating said mixer alternately in said transmit and receive mode in accordance with a TDD Control signal.

3. A method according to claim 2, further comprising the step of operating said TDD Control signal alternately with a frequency of a TDD frame.

4. A method according to claim 1, wherein said step of mixing further comprises down-converting said received RF signal to said received IF signal.

5. A method according to claim 1, wherein said step of providing a first RF signal further comprises the step of:
modulating an information signal by a modulator; and
generating said first RF signal.

6. A method according to claim 5, wherein said step of providing a second RF signal further comprises the step of providing a local oscillating (LO) signal by said modulator as said second RF signal.

7. A method according to claim 1, wherein said step of generating further comprises the step of generating said first RF signal using an oscillating means during transmit mode and said second RF signal during receive mode.

8. A method according to claim 7, further including the step of demodulating said received IF signal by a demodulator.

9. A method according to claim 8, further including the step of applying a TDD Control signal to said demodulator and said oscillating means.

10. A method according to claim 1, further comprising the step of filtering said first RF signal after amplifying said first RF signal with an amplification factor greater than, or equal to, or less than one.

11. A method according to claim 1, further comprising the step of filtering said received RF signal before said received RF signal is mixed in said mixer.

12. A method according to claim 1, further comprising the step of bandpass filtering said received RF signal and said amplified first RF signal.

13. A mixer operating in a transmit and receive mode, comprising:
a first port;
a second port;
a third port;
wherein during the transmit mode, a first RF signal is connected to said first port, said second port giving an output which consists of said first RF signal amplified with an amplification factor greater than, or equal to, or less than one; and
wherein during the receive mode, a second RF signal is connected to said first port and a received RF signal is connected to said second port, said mixer being adapted to mix said second RF signal with said received RF signal, and over said third port an output signal is provided which consists of an IF signal.

14. A mixer according to claim 13, wherein during the transmit mode, the third port is disabled.

15. A mixer according to claim 13, wherein a TDD Control signal is connected to said third port.

16. A mixer according to claim 15, wherein during transmit mode, said TDD Control signal is adapted to provide a supply voltage to said third port.

17. A mixer according to claim 15, wherein said mixer is adapted to operate alternately in said transmit and receive mode in accordance with said TDD Control signal.

18. A mixer according to claim 15, wherein said TDD Control signal is adapted to operate alternately with a frequency of a TDD frame.

19. A mixer according to claim 15, wherein said TDD Control signal consists of a square wave signal operating with a frequency of a TDD frame.

20. A mixer according to claim 13, wherein during the transmit mode, said first RF signal consists of modulated information.

21. A mixer according to claim 13, wherein during the receive mode, said second RF signal consists of a local oscillating (LO) signal.

22. A mixer according to claim 13, further comprising oscillator circuitry, said oscillator circuitry further comprising a modulator, an input signal to said modulator which consists of an information signal, giving an output signal from said modulator which consists of said first or second RF signal.

23. A mixer according to claim 22, wherein during transmit mode, said modulator is adapted to modulate said input signal and to generate said first RF signal or said second RF signal.

24. A mixer according to claim 22, wherein during the receive mode, said modulator is adapted to provide a local oscillating (LO) signal, and said input signal is zero.

25. A mixer according to claim 13, wherein said received IF signal consists of a down-converted received RF signal.

26. A mixer according to claim 13, further including a demodulator connected to said third port.

27. A mixer according to claim 22, further including a demodulator for demodulating said received IF signal.

28. A mixer according to claim 27, wherein said TDD Control signal is applied to said demodulator and an oscillator means.

29. A mixer according to claim 13, further including a filter for filtering said first RF signal after being amplified with an amplification factor greater than, or equal to, or less than one.

30. A mixer according to claim 29, wherein said received RF signal is filtered before said received RF signal is being mixed in said mixer.

31. A mixer according to claim 13, wherein said received RF signal and amplified said first RF signal are bandpass filtered.
